(19) United States
(12) Patent Application Publication
(10) Pub. No.: US 2021/0012622 A1
(43) Pub. Date: Jan. 14, 2021

(54) Scanning Devices and Methods to Constrain Radio Frequency Identification (RFID) Signals Within a Physical Location

(71) Applicant: ZEBRA TECHNOLOGIES CORPORATION, Lincolnshire, IL (US)

(72) Inventors: Darran Michael Handshaw, Sound Beach, NY (US); Christopher P. Klicpera, Westbury, NY (US)

(21) Appl. No.: 16/509,253

(22) Filed: Jul. 11, 2019

(51) Int. Cl. G07G 1/00; G06K 7/10; G06K 7/14; G06Q 20/20

(52) U.S. Cl. CPC G07G 1/009; G07G 1/0018; G06Q 20/208; G06K 7/1408; G06K 7/109

(57) ABSTRACT

Scanning devices, and related methods, for constraining RFID signals within a physical location are disclosed. An example scanning device includes a housing, an identification tag reader in the housing, the identification tag reader having an active mode in which the identification tag reader is configured to identify tags within a detection region about the housing and determine identification data for the identified tags, and the identification tag reader having an inactive mode in which the identification tag reader is prevented from detecting tags within the detection region, and a detector in the housing configured to detect a presence of a control item in an environment, the identification tag reader in the active mode when the control item is detected in the environment, and the identification tag reader in the inactive mode if the presence of the control item is not been detected.

### FIELD OF THE DISCLOSURE

This disclosure relates generally to scanning devices, and, more particularly, to scanning devices and methods to constrain radio frequency identification (RFID) signals within a physical location.

### BACKGROUND OF THE INVENTION

Scanning devices are electronic devices used to read or scan information from barcodes, RFID tags, near field communication (NFC) tags, etc. associated with packages or other items. For example, such scanning devices may be used in retail, warehouse, factory, or other environments by employees, contractors, personnel or other such users to obtain information from retail packages or other items, and may be used in applications ranging from retail sales, inventory management, shipping and tracking, and for a variety of other applications. For example, product information can be obtained from RFID tags and used to charge a customer for products associated with the tags based on the product information. Some scanning devices may incorporate multiple, different scanning technologies and related hardware to perform different functions. For example, a scanning device may contain both an imaging barcode reader for scanning barcodes, an RFID radio for reading RFID tags, and an NFC sensor for reading NFC tags.

A problem may arise, however, because an RFID reader may pick up stray RFID tags causing false positive reads, which causes unwanted data to be read. This is especially problematic in retail environments where customers or other individuals may move through high traffic areas, such as point-of-sale (POS) lanes, where scanning devices are located, causing the scanning devices to activate, and, therefore read or scan at times that are unintended.

Accordingly, there is a need for solutions that solve issues regarding scanning devices that incorporate RFID readers and related hardware, for example, via scanning devices, and related methods, for constraining RFID signals within a physical location.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments

FIG. 1 illustrates an example scanning device and an example environment of operation, in accordance with various embodiments of the invention.

FIG. 2 illustrates an example scanning device, in accordance with various embodiments of the invention, that may be used to implement the example scanning device of FIG. 1.

FIG. 3 illustrates another example scanning device, in accordance with various embodiments of the invention, that may be used to implement the example scanning device of FIG. 1.

FIG. 4 is a flowchart representative of example method, hardware logic and instructions for implementing the controller of FIG. 2 and FIG. 3.

FIG. 5 is a flowchart representative of example method, hardware logic and instructions for implementing the controller of FIG. 2 and FIG. 3.

Connecting lines or connectors shown in the various figures presented are intended to represent example functional relationships and/or physical or logical couplings between the various elements. In general, the same reference numbers will be used throughout the drawing(s) and accompanying written description to refer to the same or like parts.

Elements in the figures are illustrated for simplicity and clarity and have not necessarily been drawn to scale. For example, components may been represented where appropriate by conventional symbols in the drawings, and may show only those specific details that are pertinent to understanding the embodiments of the invention so as not to obscure the disclosure with details that will be readily apparent to those of ordinary skill in the art having the benefit of the description herein. Further, the dimensions of some of the elements in the figures may be exaggerated relative to other elements to help to improve understanding of embodiments of the invention.

### DETAILED DESCRIPTION

In various embodiments of the present disclosure, a scanning device, and related methods, are described for activating and deactivating an identification tag reader (e.g., an RFID reader) based on the location of use of the scanning device. An example scanning device includes a housing, an identification tag reader in the housing, the identification tag reader having an active mode in which the identification tag reader is configured to identify tags within a detection region about the housing and determine identification data for the identified tags, and the identification tag reader having an inactive mode in which the identification tag reader is prevented from detecting tags within the detection region, and a detector in the housing configured to detect a presence of a control item in an environment, the identification tag reader in the active mode when the control item is detected in the environment, and the identification tag reader in the inactive mode if the presence of the control item is not been detected.

Benefits may be realized by configuring an identification tag reader into an active mode only when the identification tag reader is at a designated, pre-determined, intended use location, in a designated intended use mount, etc. For example, the intended use location, mount, etc. can be selected so that only identification tags in a pre-determined detection region (e.g., a store checkout lane) can be read. When the identification tag reader is away from the pre-determined detection region (e.g., not at the intended use location, mount, etc.) and, thus, could read unintended tags (e.g., tags associated with a different checkout lane), the identification tag reader is configured to the inactive mode.

For example, a component in the scanning device interacts with another component at the intended use location, mount, etc. so as to configure the identification tag reader in the active mode when the scanning device is at the intended use location, mount, etc. and to configure the identification tag reader in the inactive mode when the scanning device is not at the intended use location, mount, etc. In some examples, the component in the scanning device is a Hall sensor and the component at the intended use location is a magnet. When the magnet is sensed by the Hall sensor, the identification tag reader is configured in the active mode. Otherwise, when the scanning device is not at the intended use location so the magnet is not sensed, the identification tag reader is configured in the inactive mode.

In some examples, the component in the scanning device is a mechanical switch and the component at the intended use location is a switch activator. When the switch activator closes the mechanical switch, the identification tag reader is configured in the active mode. Otherwise, when the scanning device is not at the intended use location so the mechanical switch is not closed by the switch activator, the identification tag reader is configured in the inactive mode.

In some examples, the component in the scanning device is a pressure switch and the component at the intended use location is a pressure activator. When the pressure activator is sensed by the pressure switch, the identification tag reader is configured in the active mode. Otherwise, when the scanning device is not at the intended use location so the pressure activator is not sensed by the pressure switch, the identification tag reader is configured in the inactive mode.

In some examples, the component in the scanning device is a light sensor and the component at the intended use location is a light source. When the light sensor senses light emitted by the light source, the identification tag reader is configured in the active mode. Otherwise, when the scanning device is not at the intended use location, the light is not detected and the identification tag reader is configured in the inactive mode.

In some examples, the component in the scanning device includes a light source and a light detector, and the component at the intended use location is an opaque member. When the light emitted by the light source is blocked from the light detector by the opaque member, the identification tag reader is configured in the active mode. Otherwise, when the scanning device is not at the intended use location so the light source is not blocked, the identification tag reader is configured in the inactive mode.

In some examples, the component in the scanning device is a color sensor and the component at the intended use location is a colored item having a predetermined color. When the predetermined color of the colored item is detected by the color sensor, the identification tag reader is configured in the active mode. Otherwise, when the scanning device is not at the intended use location so the colored item is not detected, the identification tag reader is configured in the inactive mode.

In some examples, the component in the scanning device is an NFC detector and the component at the intended use location is an NFC tag. When the NFC tag is sensed by the NFC detector, the identification tag reader is configured in the active mode. Otherwise, when the scanning device is not at the intended use location so the NFC tag is not sensed, the identification tag reader is configured in the inactive mode.

In some examples, a barcode reader system includes the scanning device and an imager configured to read barcodes.

In some examples, the intended use location is a mount for the scanning device. In some examples, the intended use location is a designated intended use location on a surface on which to set the scanning device.

An example method to constrain RFID signals within a physical intended use location includes detecting whether a scanning device having a housing and an identification tag reader disposed in the housing is located at a defined intended use location, when the scanning device is at the defined intended use location, configuring the identification tag reader in an active mode in which the identification tag reader is configured to identify tags within a detection region about the housing, and, when the scanning device is not at the defined intended use location, configuring the identification tag reader in an inactive mode in which the identification tag reader is prevented from identifying tags.

The method may further include obtaining product information associated with the tags and charging a customer for products associated with the tags based on the product information. In some examples, a mount for the scanning device defines the intended use location.

An example barcode reader to constrain RFID signals to a physical intended use location includes a housing, the barcode reader in the housing comprising an imager configured to read a barcode, and an identification tag reader in the housing having a transmit mode in which the identification tag reader is to search for and identify tags within a detection region about the housing, determine identification data for the identified tags, and transmit the determined identification data to a receiver, and a sniffing mode in which the identification tag reader is to search for an identity tag containing authenticating identification data, the identification tag reader prevented from transmitting to a receiver when in the sniffing mode, the identification tag reader configured to enter the transmit mode, from the sniffing mode, when the identification tag reader identifies the identity tag containing the authenticating identification data.

An example system to constrain RFID signals to a physical intended use location includes a barcode reader having a housing, an imager in the housing configured to read a barcode, an identification tag reader in the housing having an active mode in which the identification tag reader is to identify tags within a detection region about the housing and determine identification data for the identified tags, and the identification tag reader having an inactive mode in which the identification tag reader is prevented from detecting identity tags within the detection region, and a detector configured to detect for the presence of a control item in an environment and to enable the active mode when the control item is detected in the environment, wherein the identification tag reader is configured to be in the inactive mode if the control item presence has not been detected, and an external mount having a receiver end for engaging the housing, the receiver end configured to allow relative movement of the housing from a release position to an engaged position where the barcode reader is maintained in a fixed position, the external mount positioning the control item such that the control item is detectable by the detector when the housing is in the engaged position and not detectable by the detector when the housing is in the release position.

An example RFID module to constrain RFID signals to a physical intended use location includes an RFID tag reader configured to scan for RFID tags within a detection region, a transmitter configured to transmit, to a receiver, identification data received from RFID tags in the detection region detected by the RFID tag reader, a detector configured to detect for the presence of a control item in an environment, and a controller configured to, in response to the detector detecting the presence of the control item, switch the RFID module from an inactive mode wherein the RFID module is prevented from transmitting to the receiver to an active mode wherein the RFID module is to identify RFID tags within the detection region, determine identification data for the identified RFID tags, and transmit the identification data to the receiver.

Reference will now be made in detail to non-limiting examples, some of which are illustrated in the accompanying drawings.

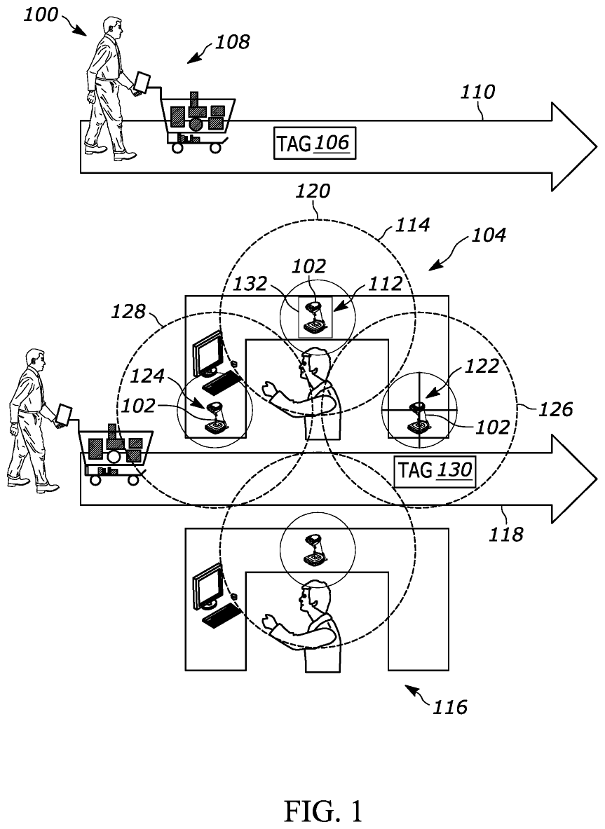

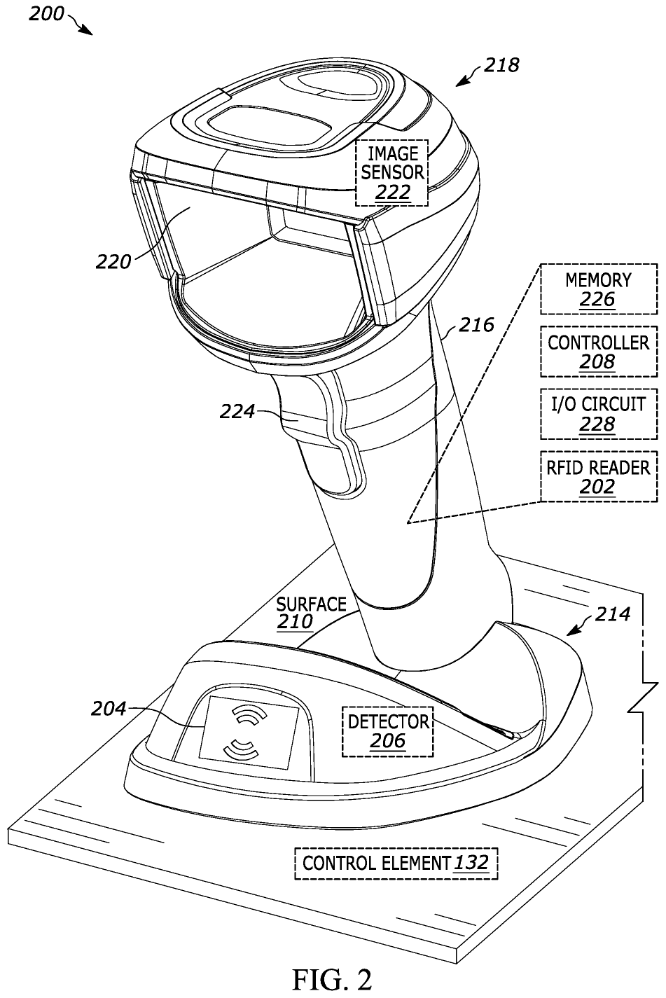

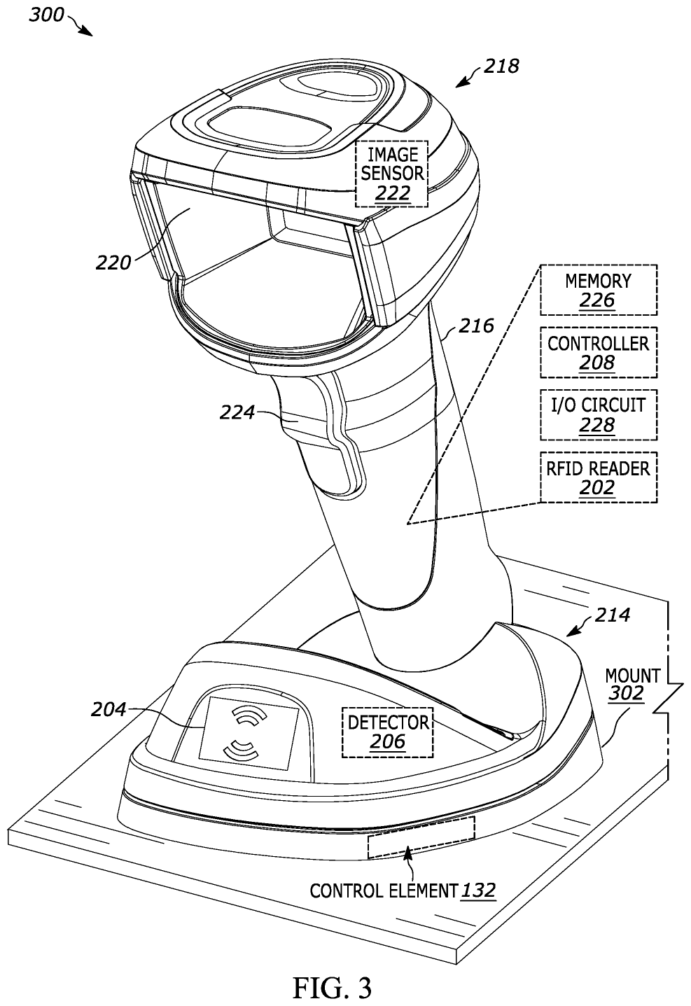

FIG. 1 illustrates an example environment 100 of operation for an example scanning device 102 (e.g., a scanner, a barcode reader, an optical tag reader, etc.), in accordance with various embodiments disclosed herein. FIG. 2 illustrates an example scanning device 200 that may be used to implement the example scanning device 102 of FIG. 1, in accordance with various embodiments disclosed herein. FIG. 3 illustrates another example scanning device 300 that may be used to implement the example scanning device 102 of FIG. 1, in accordance with various embodiments disclosed herein.

The scanning device 102 includes an identification tag reader, such as an ultra-high frequency (UHF) RFID reader 202 (see FIG. 2), associated with a POS station 104. The RFID reader 202 includes an RFID radio antenna 204 that transmits RFID signals having a predetermined, limited transmit signal strength and omnidirectional radiation field pattern (e.g., a circle). The RFID reader 202 may operate to automatically read identification tags (e.g., an RFID tag 106) within the radiation pattern emitted by RFID reader 202. In the illustrated example, the RFID reader 202 is intended to read RFID tags 106 associated with items 108 to be purchased. The items 108 can be, for example, pushed in a cart or carried down a checkout lane 110, or held or set down on a surface of the POS station 104. Aspects of this invention may be used to read RFID tags 106 for other purposes. For example, in a warehouse, in a shipping facility, for inventory purposes, for sorting purposes, for tracking purposes, for maintenance purposes, etc.

When the scanning device 102 is positioned at an example intended use location 112 where the RFID reader 202 is intended to be used to read RFID tags, the RFID reader 202 emits (e.g., transmits, radiates, etc.) RFID signals having a desired radiation field pattern (e.g., according to a circle 114) into the lane 110. Accordingly, the RFID reader 202 can read RFID tags 106 present in the lane 110 that are within the emitted radiation pattern (e.g., within the circle 114). The RFID reader 202 has a limited transmit strength and, thus, when positioned at the location 112, the RFID signal transmitted by the RFID reader 202 will not extend into other POS stations (e.g., a POS station 116). Accordingly, the RFID reader 202 will not mistakenly read RFID tags present in a lane 118 of the POS station 116. That is, the RFID signals are constrained to within a desired region (e.g., an area, a detection region 120, etc.) about the location 112 that does not include the POS 116.

When the scanning device 102 is instead positioned at a different unintended use location (e.g., an unintended use location 122 or an unintended use location 124) where the RFID reader 202 is not intended to be used, the RFID reader 202 can unintentionally transmit RFID signals in a radiation field pattern (represented by a respective circle 126 or circle 128) into the lane 118 of the POS 116. That is, the RFID signals 126, 128 are no longer constrained to within a region that does not include the POS 116. Accordingly, when the RFID reader 202 is at either of the unintended use locations 122, 124, their respective RFID signals 126, 128 extend into the POS station 116 and, thus, the RFID reader 202 can mistakenly read identification tags (e.g., an RFID tag 130) present in the lane 118. Furthermore, in the illustrated example, the RFID signals 126, 128 do not extend into the lane 110 of the POS station 104 and, thus, the RFID reader 202 is unable to detect items 108 that are intended to be purchased in the lane 110.

To prevent the RFID reader 202 from reading RFID tags 106 at unintended use locations (e.g., the locations 122, 124), the example scanning device 102 includes an example detector 206 and an example controller 208 (see FIG. 2). Control elements (e.g., a control element 132) corresponding to the detector 206 are disposed at intended use locations of operation (e.g., the location 112), but are not disposed at other locations (e.g., either of the locations 122, 124). When the detector 206 detects the presence of the control element 132, the scanning device 102 is known or determined to be at an intended use location (e.g., the location 112). When the detector 206 does not detect the presence of the control element 132, the scanning device 102 is known or determined to not be located at an intended use location of operation (e.g., the location 112). Accordingly, when the detector 206 detects the presence of the control element 132, the controller 208 enables the RFID reader 202 (e.g., places or configures it in an active mode, activates it, turns it on, etc.). Otherwise, the controller 208 disables the RFID reader 202 (e.g., places or configures it in an inactive mode, deactivates it, turns it off, places it in a sniffing mode, etc.). Because there is not a control element at either of the unintended use locations 122, 124, when the scanning device 102 is located at either of those locations, the detector 206 will not detect a control element, and the controller 208 will disable the RFID reader 202, thereby, preventing the RFID reader 202 from reading RFID tags in the lane 118.

In some example control configurations, to constrain RFID signals within a physical location, an intended use location is an example surface 210 (see FIG. 2) of the POS station 104 on which the scanning device 102 is intended to be placed and used. The surface 210 has a control item 132 disposed at, around, on, or beneath the surface 210 at or near the location 112 so the control item 132 is detectable by the detector 206 when a base 214 of the scanning device 102 is set on the surface 210 at the location 112, and not detectable by the detector 206 when the base 214 is removed from the surface 210.

In some example control configurations, to constrain RFID signals within a physical location, an example intended use location is an example mount 302 (see FIG. 3) that includes a receiver for engaging the base 214 of the housing 216 of a scanning device 300. The receiver allows relative movement of the base 214 between a released position and an engaged position where the scanning device 102 is maintained in a fixed position. The control item 132 is disposed in the mount 302 so the control item 132 is detectable by the detector 206 when the base 214 is in the engaged position, and not detectable by the detector 206 when the base 214 is in the released position. The relative movement may be a translational movement, a rotational movement, etc. For example, the mount 302 may have a translational engagement, where the housing 216 translates (or slides) into an engaged position, and the control element is not detectable until the housing 216 has fully translated into the mount 302. In some examples, the mount 302 may have rotational engagement, in which the housing 216 rotates into the engaged positioned, and the control element 132 is not detectable until the housing 216 has fully rotated into that engaged position. Such relative movement and location of the control element 132 can provide an added benefit of ensuring that the scanning device 300 is pointed in the proper direction during its active mode. As will be appreciated, other control element and detector configurations allow free movement of the scanning device 300.

The scanning device 300 of FIG. 3 may differ from the scanning device 200 when, for example, the base 214 of the scanning device 300 is modified to mount to the mount 302. In other aspects, e.g., reading RFID tags and determining whether the scanning device 300 is at an intended use location, the scanning device 300 may be similar to or identical to the scanning device 200. Accordingly, the identical elements in the examples of FIG. 2 and FIG. 3 are identically numbered. Thus, the interested reader should refer to the descriptions of FIG. 2 regarding the identical elements in FIG. 3.

In some examples, the detector 206 includes a Hall sensor, and the control item 132 includes a magnet. When the Hall sensor detects the magnet, the controller 208 places the RFID reader 202 in the active mode.

In some examples, the detector 206 includes a mechanical switch, and the control item 132 includes a switch activator that changes the state of the mechanical switch. For example, when the switch activator closes the mechanical switch, the controller 28 places the RFID reader 202 in the active mode.

In some examples, the detector 206 includes a pressure switch, and the control item 132 includes a pressure inducer. When the pressure inducer closes the pressure switch, the controller 208 places the RFID reader 202 in the active mode.

In some examples, the detector 206 includes a light sensor, and the control item 132 includes a light source. When the light sensor detects an interruption of light emitted by the light source, the controller 208 places the RFID reader 202 in the inactive mode.

In some examples, the detector 206 includes a light source and a light sensor, and the control item 132 includes an opaque member. When the light sensor does not sense the light emitted by the light source due to the opaque member, the controller 208 places the RFID reader 202 in the active mode.

In some examples, the detector 206 includes a color sensor, and the control item 132 includes a colored member having a predetermined color. When the color sensor detects the predetermined color of the colored member, the controller 208 places the RFID reader 202 in the active mode.

In some examples, the detector 206 includes an NFC sensor or the RFID reader 202, and the control item 132 includes a special identification NFC or RFID tag. When the NFC sensor or RFID reader 202 detects the special identification NFC or RFID tag, the controller 208 places the RFID reader 202 in the active mode. When the NFC sensor or RFID reader 202 does not detect the special identification NFC or RFID tag, the controller 208 places the RFID reader 202 in the inactive mode. In some examples, the NFC sensor or RFID reader 202 is placed in a sniffing mode for the special identification NFC or RFID tag rather than being placed in the inactive mode. The controller 208 may set operating parameters for the active mode based on control data read from the special identification NFC or RFID tag.

In some examples, the detector 206 includes a light source in the base 214 of the housing 216, and the base 214 includes a stopper positioned to block the light source when the scanning device 102 is mounted to the base 214. When the detector 206 detects the light source is blocked, the controller 208 places the RFID reader 202 in the active mode.

An example barcode reader system includes the scanning device 102, an optical imaging assembly 218, and a scanning window 220 (see FIG. 2). The optical imaging assembly 218 includes an image sensor 222 that includes a plurality of photo-sensitive elements (not shown). The photo-sensitive elements may be arranged in a pattern and may form a substantially flat surface. For example, the photo-sensitive elements may be arranged in a grid or a series of arrays forming a 2D surface. The image sensor 222 of the optical imaging assembly 218 may have an imaging axis that extends through the scanning window 220 for the purpose of capturing 1D or 2D images (e.g., barcodes).

The scanning device 102 may further include a trigger 224. In some embodiments, the trigger 224 activates each of the optical imaging assembly 218 and the RFID reader 202 together for a scanning session. In other embodiments, the trigger 224 may be configured to activate, at least initially, one of the optical imaging assembly 218 or the RFID reader 202 where, for example, a top portion of the trigger 224 activates the optical imaging assembly 218 and a bottom portion of the trigger 224 activates the RFID reader 202, or vice versa. It is to be understood however, that activation of the optical imaging assembly 218 and/or the RFID reader 202 need not occur solely through the trigger 224, and that the scanning device 102 may also operate in a hands-free mode where activation of the optical imaging assembly 218 and/or the RFID reader 202 may occur upon the detection of products in the vicinity, field of view, effective reading range, etc. of scanning device 102.

In some examples, the controller 208 is implemented in a POS terminal to which the scanning device 200 is coupled. Example controllers 208 include a programmable processor, a programmable controller, a graphics processing unit (GPU), a digital signal processor (DSP), etc. Alternatively, an application specific integrated circuit (ASIC), a programmable logic device (PLD), a field programmable gate array (FPGA), a field programmable logic device (FPLD), a logic circuit, etc.) may be structured or configured to implement the controller 208.

The scanning device 200 includes memory 226 to store software, and machine- or computer-readable instructions, which may be executed by the controller 208. Example memories 226 include any number or type(s) of non-transitory computer- or machine-readable storage medium or disk, such as a hard disk drive (HDD), an optical storage drive, a solid-state storage device, a solid-state drive (SSD), a read-only memory (ROM), a random-access memory (RAM), a compact disc (CD), a compact disc read-only memory (CD-ROM), a digital versatile disk (DVD), a Blu-ray disk, a cache, a flash memory, or any other storage device or storage disk in which information may be stored for any duration (e.g., permanently, for an extended time period, for a brief instance, for temporarily buffering, for caching of the information, etc.).

As used herein, the term non-transitory computer-readable medium is expressly defined to include any type of computer-readable storage device and/or storage disk and to exclude propagating signals and to exclude transmission media. As used herein, the term non-transitory machine-readable medium is expressly defined to include any type of machine-readable storage device and/or storage disk and to exclude propagating signals and to exclude transmission media.

The scanning device 200 includes an input/output (I/O) circuit 228 to couple the controller 208 to, among possibly other elements, the RFID reader 202, the detector 206, another component of a POS station (e.g., a terminal), etc.

While an example scanning device 200 is shown in FIG. 2, one or more of the elements, processes and devices illustrated in FIG. 1 may be combined, divided, re-arranged, omitted, eliminated or implemented in any other way. Further, the scanning device 200 may include one or more elements, processes or devices in addition to, or instead of, those illustrated in FIG. 2, or may include more than one of any or all of the illustrated elements, processes and devices.

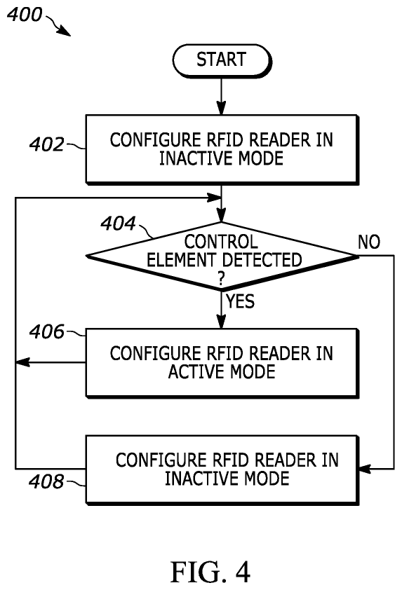

A flowchart 400 representative of example processes, methods, software, firmware, and computer- or machine-readable instructions for implementing the controller 208 of FIG. 2 and FIG. 3 is shown in FIG. 4. The processes, methods, software and instructions may be an executable program or portion of an executable program for execution by a processor such as the controller 208. The program may be embodied in software or instructions stored on a non-transitory computer- or machine-readable storage medium or disk associated with the controller 208. Further, although the example program is described with reference to the flowchart illustrated in FIG. 4, many other methods of implementing the example controller 208 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., discrete and/or integrated analog and/or digital circuitry, an ASIC, a PLD, an FPGA, an FPLD, a logic circuit, etc.) structured to perform the corresponding operations without executing software or firmware. Of course, a combination of the two approaches could be used.

FIG. 4 illustrates an example process for switching between operating modes of the scanning device 200, 300. The process begins with scanning device 200, 300 searching for a control element 132, while in a first mode. That first mode may be an inactive mode, in which the scanning device 200, 300 is prevented from identifying RFID tags within the detection region about the housing 216. The controller 208 controls the detector 206 to search for a control element 132 in a localized area (block 402). The controller 208 then determines if the detector 206 has detected the control element 132 (block 404). If the control element 132 is detected (block 404), the controller 208 places the RFID reader 202 in the active mode (block 406), and control returns to block 404. For example, the controller 208 may switch the scanning device 200, 300 from a searching mode or other inactive mode to the active mode ready for identifying tags within the detection region. Otherwise, the controller 208 places the RFID reader 202 in the inactive mode (408) or maintains the RFID reader 202 in the active mode, and control returns to block 404.

When a special RFID or NFC tag is used as the control element 132, the controller 208 places RFID reader 202 or NFC sensor in a sniffing mode for the special NFC or RFID tag rather than being placed in the inactive mode.

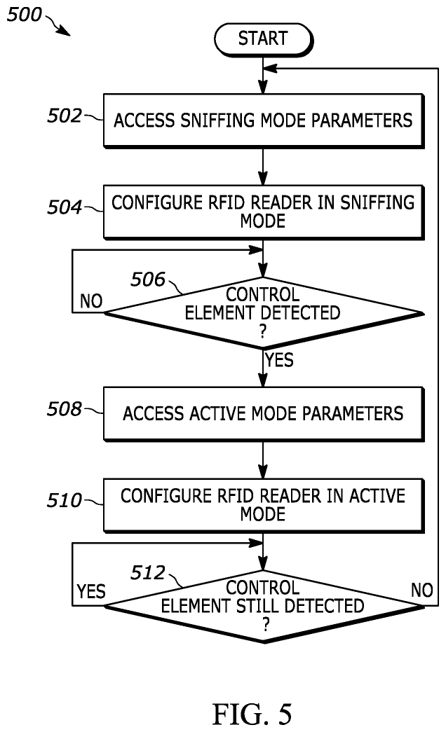

FIG. 5 illustrates a similar process to the process of FIG. 4, but in which the scanning device 200, 300 starts in a sniffing mode to sniff for a special NFC or RFID tag rather than being placed in the inactive mode as shown in FIG. 4. The controller 208 accesses (e.g., obtains, reads, etc.) sniffing mode parameters (block 502), and controls the detector 206 (e.g., an NFC reader or the RFID reader 202) into the sniffing mode according to the accessed sniffing mode parameters (block 504). The sniffing mode parameters may be accessed from a local memory, a special NFC tag or a special RFID tag. Example parameters include RFID scan parameters, antenna configuration settings, RF power settings, illumination settings (e.g., on/off, intensity, switching between LEDs, etc.), sound settings (e.g., volume, tone, specific audio file playing, etc.), read range of either the RFID or barcode scanner, etc. Additionally, and/or alternatively use RFID control tag to enable or disable only certain barcode or tag types, rather than all tag types, change the beeper tone when a tag or barcode is read, tag timeout, RFID trigger mode, RFID cache management, etc. The controller 208 then determines if the detector 206 has detected the control element 132 (block 506). If the control element 132 is detected (block 506), the controller 208 accesses (e.g., obtains, reads, etc.) active mode parameters (block 508), and controls the RFID reader 202 into the active mode according to the accessed active mode parameters (block 510). When the control element 132 is no longer detected (block 512), control returns to block 502 to configure the detector 206 into the sniffing mode (block 502).

In the foregoing specification, specific embodiments have been described. However, one of ordinary skill in the art appreciates that various modifications and changes can be made in view of aspects of this disclosure without departing from the scope of the invention as set forth in the claims below. Accordingly, the specification and figures are to be regarded in an illustrative rather than a restrictive sense, and all such modifications made in view of aspects of this disclosure are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The term “coupled” as used herein is defined as connected, although not necessarily directly and not necessarily mechanically. A device or structure that is “configured” in a certain way is configured in at least that way, but may also be configured in ways that are not listed.

Further, unless expressly stated to the contrary, “or” refers to an inclusive or and not to an exclusive or. For example, A, B or C refers to any combination or subset of A, B, C such as (1) A alone, (2) B alone, (3) C alone, (4) A with B, (5) A with C, (6) B with C, and (7) A with B and with C. As used herein, the phrase “at least one of A or B” is intended to refer to implementations including any of (1) at least one A, (2) at least one B, and (3) at least one A and at least one B. Similarly, the phrase “at least one of A and B” is intended to refer to implementations including any of (1) at least one A, (2) at least one B, and (3) at least one A and at least one B. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

As used herein, the expressions “in communication,” “coupled” and “connected,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim and/or combinations thereof standing on its own as a separately claimed subject matter.

This patent covers all methods, apparatus and articles of manufacture fairly falling within the scope of the claims of this patent.

1. A scanning device comprising:
a housing, the housing being movable by an operator;
an identification tag reader in the housing, the identification tag reader having an active mode in which the identification tag reader is configured to identify tags within a detection region about the housing and determine identification data for the identified tags, and the identification tag reader having an inactive mode in which the identification tag reader is prevented from detecting tags within the detection region; and
a detector in the housing configured to detect a presence of a control item in an environment, the control item being statically located in the environment, the identification tag reader in the active mode when the control item is detected in the environment, and the identification tag reader in the inactive mode if the presence of the control item has not been detected.

2. The scanning device of claim 1, wherein the housing has a base portion for supporting the scanning device at an intended use location for placing the scanning device in the active mode, the detector comprising a Hall sensor in the base portion configured to detect a presence of a magnet at the intended use location as the control item.

3. A barcode reader system comprising the scanning device of claim 2, an imager configured to read a barcode, an external mount as the intended use location, and the magnet.

4. The scanning device of claim 1, wherein the housing has a base portion for supporting the scanning device at an intended use location thereby placing the scanning device in the active mode, the detector comprising a mechanical switch in the base portion and configured to detect a presence of a switch activator at the intended use location as the control item.

5. A barcode reader system comprising the scanning device of claim 4, an imager in the housing configured to read a barcode, an external mount as the intended use location, and the switch activator.

6. The scanning device of claim 1, wherein the housing has a base portion for supporting the scanning device at an intended use location thereby placing the scanning device in the active mode, the detector comprising a pressure switch in the base portion and configured to detect a presence of a pressure inducer at the intended use location as the control item.

7. A barcode reader system comprising the scanning device of claim 6, an imager in the housing configured to read a barcode, an external mount as the intended use location, and a pressure inducing element configured to engage the pressure switch of the base portion.

8. The scanning device of claim 1, wherein the housing has a base portion for supporting the scanning device at an intended use location thereby placing the scanning device in the active mode, the detector comprising a light sensor in the base portion and configured to detect a presence of a light source at the intended use location as the control item.

9. A barcode reader system comprising the scanning device of claim 8, an imager in the housing configured to read a barcode, an external mount as the intended use location, and the light source as the control item.

10. The scanning device of claim 1, wherein the housing has a base portion for supporting the scanning device at an intended use location thereby placing the scanning device in the active mode, the detector comprising a light source and light sensor in the base portion and configured to detect an interruption of transmitted light from the light source when the scanning device is located at the intended use location, where the interruption is due to an opaque member at the intended use location as the control item.

11. A barcode reader system comprising the scanning device of claim 10, an imager in the housing configured to read a barcode, and an external mount as the intended use location having the opaque member positioned to interrupt a transmission of light from the light source, when the base portion is positioned at the external mount.

12. The scanning device of claim 1, wherein the housing has a base portion for supporting the scanning device at an intended use location thereby placing the scanning device in the active mode, the detector comprising a color sensor in the base portion and configured to detect a predetermined color of a colored member in the detection region as the control item.

13. The scanning device of claim 1, further including a controller to:
configure the identification tag reader in the active mode when the control item is detected in the environment; and
configure the identification tag reader in the inactive mode if the presence of the control item has not been detected.

14. The scanning device of claim 1, wherein the detector is a near-field communication (NFC) detector configured to detect a presence of an NFC tag within the environment as the control item.

15. The scanning device of claim 14, wherein the detector is configured to receive control data from the detected NFC tag and to set operating parameters for the active mode based on the control data.

16. The scanning device of claim 14, wherein the detector is configured to switch the identification tag reader from the active mode to the inactive mode when the detector does not detect the presence of the NFC tag within the environment.

17. The scanning device of claim 1, wherein the identification tag reader is a radio frequency identification (RFID) detector.

18. A method of configuring a scanning device having a housing movable by an operator, an identification tag reader disposed in the housing, and a detector disposed in the housing, the method comprising:
detecting whether the detector detects a control element at a defined location, the control element being statically located at the defined location;
when the control element is detected, configuring the identification tag reader in an active mode in which the identification tag reader is configured to identify tags within a detection region about the housing; and
when the control element is not detected, configuring the identification tag reader in an inactive mode in which the identification tag reader is prevented from identifying tags within the detection region about the housing.

19. The method of claim 18, further comprising, in the active mode, obtaining product information associated with the tags, and charging a customer for products associated with the tags based on the product information.

20. The method of claim 18, wherein detecting whether the detector detects the control element includes at least one of a first detection of a magnet with a Hall sensor, a second detection of an activation of a mechanical switch, a third detection of an activation of a pressure switch, a fourth detection of light, or a fifth detection of a near-field communication (NFC) tag.

21. The method of claim 18, wherein a mount for the scanning device forms the defined location.

22. A barcode reader, comprising:
a housing, the housing being movable by an operator;
an imager in the housing configured to read a barcode; and
an identification tag reader in the housing having:
a transmit mode in which the identification tag reader is to search for and identify tags within a detection region about the housing, determine identification data for the identified tags, and transmit the determined identification data to a receiver; and
a sniffing mode in which the identification tag reader is to search for an identity tag containing authenticating identification data, the identification tag reader prevented from transmitting to the receiver when in the sniffing mode,
the identification tag reader configured to enter the transmit mode, from the sniffing mode, when the identification tag reader identifies the identity tag containing the authenticating identification data.

23. A system, comprising:
a barcode reader having,
a housing, the housing being movable by an operator,
an imager in the housing configured to read a barcode,
an identification tag reader in the housing having an active mode in which the identification tag reader is to identify tags within a detection region about the housing and determine identification data for the identified tags, and the identification tag reader having an inactive mode in which the identification tag reader is prevented from detecting identity tags within the detection region, and
a detector configured to detect for a presence of a control item in an environment, the control item being statically located in the environment, and to enable the active mode when the control item is detected in the environment, wherein the identification tag reader is configured to be in the inactive mode if the control item presence has not been detected; and
an external mount having a receiver end for engaging the housing, the receiver end configured to allow relative movement of the housing from a release position to an engaged position where the barcode reader is maintained in a fixed position, the external mount positioning the control item such that the control item is detectable by the detector when the housing is in the engaged position and not detectable by the detector when the housing is in the release position.

24. The system of claim 23, wherein the receiver end is configured to allow translational movement of the housing relative to the external mount.

25. The system of claim 23, wherein the receiver end is configured to allow rotational movement of the housing relative to the external mount.

26. The system of claim 23, wherein the detector comprises a hall sensor in a base portion of the housing and the external mount comprises a magnet as the control item.

27. The system of claim 23, wherein the detector comprises a mechanical switch in a base portion of the housing and the external mount comprises a switch activator as the control item.

28. The system of claim 23, wherein the detector comprises a pressure switch in a base portion of the housing and the external mount comprises a pressure activator as the control item.

29. The system of claim 23, wherein the detector comprises a light source in a base portion of the housing and the external mount comprises a stopper positioned to block the light source when the housing is in the fixed position.

30. A radio frequency identification (RFID) module, comprising:
an RFID tag reader configured to scan for RFID tags within a detection region, the RFID tag reader being movable by an operator;
a transmitter configured to transmit, to a receiver, identification data received from RFID tags in the detection region detected by the RFID tag reader;
a detector configured to detect for a presence of a control item in an environment; and
a controller configured to, in response to the detector detecting the presence of the control item, the control item being statically located in the environment, switch the RFID module from an inactive mode wherein the RFID module is prevented from transmitting to the receiver to an active mode wherein the RFID module is to identify RFID tags within the detection region, determine identification data for the identified RFID tags, and transmit the identification data to the receiver.
